(19) United States
(12) Patent Application Publication
(10) Pub. No.: US 2011/0294104 A1
(43) Pub. Date: Dec. 1, 2011

(54) REMOTE CONTROL, KARAOKE DEVICE, AND SONG SELECTING METHOD

(75) Inventors: ZHI-LAN SHI, Shenzhen City (CN); JIAN-HUA LONG, Shenzhen City (CN); YANG LUO, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/853,320

(22) Filed: Aug. 10, 2010

(30) Foreign Application Priority Data
May 28, 2010 (CN) 201010186091.4

(51) Int. Cl. G06F 7/04; G10H 7/00

(52) U.S. Cl. 434/307 A; 340/5.64

(57) ABSTRACT

A remote control controls a karaoke device to select songs. The remote control stores a controller identifier, obtains a user unique code and control instructions input by a song selector, and combines the controller identifier, the user unique code, and each of the control instructions into a controlling message. The remote control transmits the controlling messages to the karaoke device to enable the karaoke device to collectively display the songs selected by the song selector and the user unique code corresponding to the song selector.

### BACKGROUND

1. Technical Field

Embodiments of the present disclosure relate to karaoke system, and more particularly to a remote control, a karaoke device, and a song selecting method.

2. Description of Related Art

A karaoke system provides a karaoke device and a remote control. A song selector uses the remote control to select songs in the karaoke device. The karaoke device displays the selected songs in sequence. However, several song selectors may use the karaoke system at one time. The karaoke device displays selected songs in sequence on a screen of the karaoke device, and most song selectors cannot know who has selected which of the songs, which is inconvenient.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of a remote control and a karaoke device of the present disclosure;

FIG. 2 is a schematic diagram of a controlling message transmitted to the karaoke device by the remote control of FIG. 1; and

FIG. 3 is a flowchart of a song selecting method of one embodiment of the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

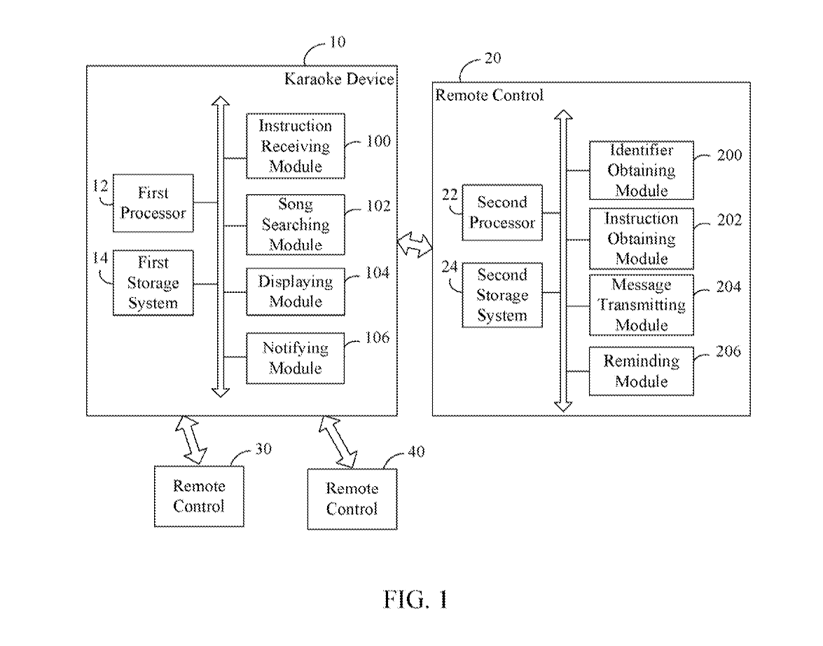

FIG. 1 is a schematic diagram of functional modules of one embodiment of a karaoke device 10 and a plurality of remote controls 20, 30, 40, of the present disclosure. It is noted that there may be more remote controls to control the selection device 10. All of the remote controls have same structures, and FIG. 1 only shows functional modules of the remote control 20 for simplicity. The remote controls control the karaoke device 10 to select songs. The remote control 20 is taken as a non-limiting example.

In one embodiment, the karaoke device 10 includes a first processor 12, a first storage system 14, an instruction receiving module 100, a song searching module 102, a displaying module 104, and a notifying module 106. Those modules may include programs comprising one or more programs stored in the first storage system 14 and executed by the first processor 12.

In one embodiment, the remote control 20 includes a second processor 22, a second storage system 24, an identifier obtaining module 200, an instruction obtaining module 202, a message transmitting module 204, and a reminding module 206. Those modules may include programs comprising one or more programs stored in the second storage system 24 and executed by the second processor 22. The remote control 20 has a controller identifier stored in the second storage system 24 to identify manufacture of the remote control 20.

When using the remote control 20 for the first time, a song selector inputs a user unique code via a keypad of the remote control 20. Then, the identifier obtaining module 200 obtains the user unique code input by the song selector. The user unique code uniquely identifies the song selector, and may be a name of the song selector. When another song selector uses the remote control 20, the identifier obtaining module 200 further obtains a new user unique code input by the another song selector to replace the original user unique code.

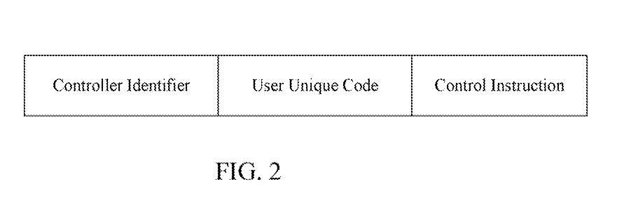

The song selector uses the remote control 20 to input a plurality of control instructions to select songs in the karaoke device 10. Then, the instruction obtaining module 202 obtains control instructions input by the song selector. The message transmitting module 204 combines the controller identifier, the user unique code, and each of the control instructions into a controlling message, and then transmits the controlling message to the karaoke device 10. FIG. 2 is a schematic diagram of the controlling message.

Then, the instruction receiving module 100 of the karaoke device 10 receives the controlling messages from the remote control 20 to select songs. The song searching module 102 searches songs according to the control instructions and the corresponding user unique code. The displaying module 104 displays the searched songs and the corresponding user unique code on a screen of the karaoke device 10.

Therefore, the karaoke device 10 can collectively display the selected songs and the corresponding song selectors. All the song selectors can know who selects the songs just by the displaying of the karaoke device 10.

When the karaoke device 10 is broadcasting a singing song, the notifying module 106 detects the user unique code corresponding to a next singing song, and transmits a notification to the remote control 20 corresponding to the user unique code to remind the song selector to sing the next sing song. Then, the reminding module 206 of the remote control 20 reminds the song selector when receiving the notification from the karaoke device 10. Therefore, the remote control 20 can remind its user that the next singing song is selected by he or she and the user can prepare to sing the next song.

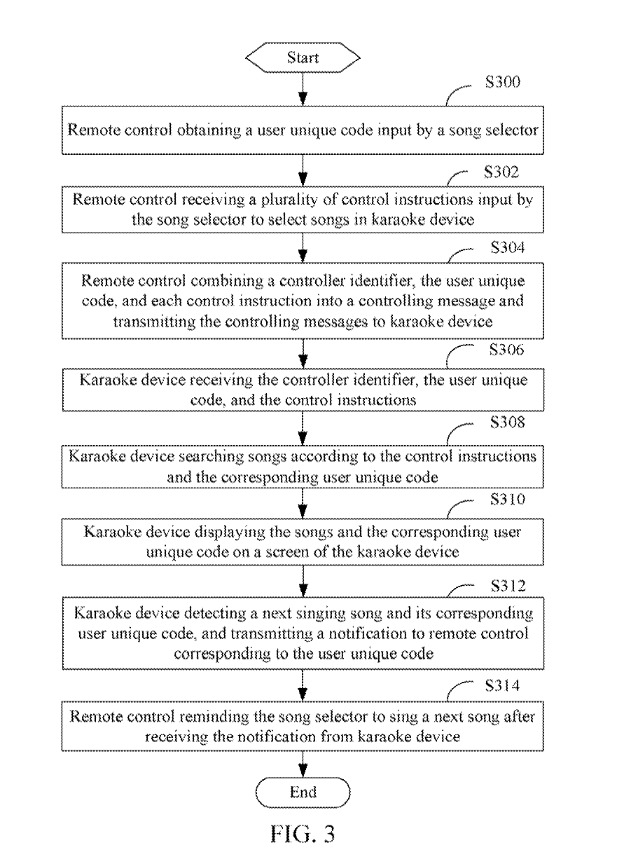

FIG. 3 is a flowchart of a song selecting method of one embodiment of the present disclosure. The flowchart is executed by the modules of FIG. 1. Depending on the embodiment, additional blocks may be added, others deleted, and the ordering of blocks may be changed while remaining well within the scope of the disclosure.

In block S300, the identifier obtaining module 200 of the remote control 20 obtains a user unique code input by a song selector. In block S302, the instruction obtaining module 202 of the remote control 20 obtains a plurality of control instructions input by the song selector. In block S304, the message transmitting module 204 of the remote control 20 combines a controller identifier, the user unique code, and each of the control instructions into a controlling message, and then transmits the controlling message to the karaoke device 10.

In block S306, the instruction receiving module 100 of the karaoke device 10 receives the controlling messages from the remote control 20 to select songs. In block S308, the song searching module 102 of the karaoke device 10 searches songs according to the control instructions and the corresponding user unique code. In block S310, the displaying module 104 of the karaoke device 10 displays the searched songs and the corresponding user unique code on the screen of the karaoke device 10.

In block S312, the notifying module 106 of the karaoke device 10 detects a next singing song and its corresponding user unique code, and transmits a notification to the remote control 20 corresponding to the user unique code to remind the song selector to sing the next song. Then in block S314, the reminding module 206 of the remote control 20 reminds the song selector when receiving the notification from the karaoke device 10.

The karaoke device 10 of the present disclosure can display the selected songs and the corresponding song selectors under controlling of the remote control 20, 30, 40 of the present disclosure. Thus, all the song selectors can know who selects the songs just by the displaying of the karaoke device 10, which is more convenient. In addition, the remote control 20, 30, 40 of the present disclosure can remind its user that the next singing song is selected by he or she and the user can prepare to sing the next song.

While various embodiments of the present disclosure have been described above, it should be understood that they have been presented by way of example only and not by way of limitation. Thus the breadth and scope of the present disclosure should not be limited by the above-described embodiments, but should be defined only in accordance with the following claims and their equivalents.

What is claimed is:

1. A remote control for a karaoke device, the remote control comprising a processor, a storage system storing a controller identifier of the remote control, and one or more programs stored in the storage system and operable to be executed by the processor, the one or more programs comprising:
an identifier obtaining module to obtain a user unique code defined and input by a song selector;
an instruction obtaining module to obtain a plurality of control instructions input by the song selector; and
a message transmitting module to combine the controller identifier, the user unique code, and each of the control instructions into a controlling message, and to transmit the controlling message to the karaoke device to enable the karaoke device to collectively display the songs selected by the song selector and the user unique code corresponding to the song selector.

2. The remote control as claimed in claim 1, wherein the identifier obtaining module further obtains a new user unique code input by a newly joined song selector.

3. The remote control as claimed in claim 1, further comprising a reminding module to remind the song selector to sing a next song when receiving a notification from the karaoke device, wherein the karaoke device detects the user unique code corresponding to the next singing song, and transmits the notification to the remote control corresponding to the user unique code.

4. A karaoke device to select songs under remote control of a remote control, the karaoke device comprising a processor, a storage system, and one or more programs stored in the storage system and operable to be executed by the processor and comprising:
an instruction receiving module to receive a plurality of controlling messages from the remote control to select songs by a song selector, each of the controlling messages comprising a controller identifier of the remote control, a user unique code of the song selector, and a control instruction to select songs;
a song searching module to search songs according to the control instructions and the corresponding user unique code; and
a displaying module to display the searched songs and the corresponding user unique code.

5. The karaoke device as claimed in claim 4, further comprising: a notifying module to detect the user unique code corresponding to a next singing song, and to transmit a notification to the remote control corresponding to the user unique code to remind the song selector to sing the next song.

6. A song selecting method of a remote control to control a karaoke device, the song selecting method comprising:
the remote control obtaining a user unique code input by a song selector;
the remote control obtaining a plurality of control instructions input by the song selector; and
the remote control combining the controller identifier, the user unique code, and each of the control instructions into a controlling message;
the remote control transmitting the controlling message to the karaoke device;
the karaoke device receiving a plurality of controlling messages from the remote control to select songs by a song selector;
the karaoke device searching songs according to the control instructions and the corresponding user unique code; and
the karaoke device displaying the searched songs and the corresponding user unique code.

7. The method as claimed in claim 6, further comprising:
the karaoke device detecting the user unique code corresponding to a next singing song;
the karaoke device transmitting a notification to the remote control corresponding to the user unique code;
the remote control receiving the notification from the karaoke device; and
the remote control reminding the song selector to sing a next song.

8. The method as claimed in claim 6, further comprising: the remote control obtaining a new user unique code input by another song selector to replace the original user unique code.
